(19) United States
(12) Patent Application Publication
(10) Pub. No.: US 2009/0256045 A1
(43) Pub. Date: Oct. 15, 2009

(54) HANGING SYSTEM

(76) Inventor: Thomas Tunberg, Santa Barara, CA (US)

Correspondence Address: THE ECLIPSE GROUP LLP, 10605 BALBOA BLVD., SUITE 300, GRANADA HILLS, CA, 91344, US

(21) Appl. No.: 11/574,564

(22) PCT Filed: Dec. 5, 2006
(86) PCT No.: PCT/US06/46372

§ 371 Date: Mar. 1, 2007

Related U.S. Application Data
(60) Provisional application No. 60/742,601, filed on Dec. 5, 2005.

(51) Int. Cl. F16M 13/00

(52) U.S. Cl. 248/339

(57) ABSTRACT

A hanging system that includes a hanging device having a hanger strip with an upper hook section on one end of the strip and at least one hook attachment position on the other end of the strip. The plurality of hook attachment positions are positioned along the length of the hanger strip for attachment of at least one hook. The hanger strip may be hung by the upper hook section from a top of a vertical surface. The hanger strip may also be hung from a support bracket installed on the vertical surface. The at least one hooks may be inserted into the hook attachments and used to hold a hanging object suspended from the vertical surface.

### CROSS-REFERENCE TO RELATED APPLICATIONS

This application claims priority of U.S. Provisional Patent Application Ser. No. 60/742,601 filed on Dec. 5, 2005, titled “Hanging System,” which is incorporated by reference in this application in its entirety.

### BACKGROUND OF THE INVENTION

1. Field of the Invention

This invention relates generally to a system for hanging or mounting items, such as pictures or artwork, against a wall or other vertical surface.

2. Related Art

Typically, frames with pictures, artwork, mirrors, or other items for display on a wall are mounted on a wall or vertical surface by hanging on a hook affixed to the wall. The hook may be screwed into the wall, fastened by a nail, or by other means of fixing to the wall. Frames typically have a wire or a line running behind the frame between points of attachment on opposite sides of the frame. The frame is then mounted to the wall by putting the wire in the hook.

One problem with the use of fixed hooks is that they are fixtures. There is little flexibility in changing the position of the frame on the wall. There is some flexibility in moving the frame from side to side, but it is limited by the way the frame slants when moved to far to one side. In addition, in places where it may be necessary to replace a frame with another frame with some regularity—such as in an art gallery—the same location of the hook for one frame may not be acceptable for a different frame, requiring a new hook fixture. It is also typically necessary to replace the hooks using tools such as a drill, wrench, screwdriver, etc. It may also be necessary to mount a ladder to perform the mounting.

Therefore, there is a need for methods and systems for hanging frames that overcomes the disadvantages set forth above and others previously experienced.

### SUMMARY

In view of the above, a hanging system consistent with the present invention is provided. The hanging system includes a hanging device having a hanger strip with an upper hook and a plurality of hook attachment positions. The plurality of hook attachment positions are positioned along the length of the hanger strip for attachment of at least one hook.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 illustrates an example of a hanging system consistent with the present invention.

FIG. 2 shows an example of the hanging system used to hang a frame.

FIG. 3 is a top view of an example of a supporting bracket mounted to a wall.

FIG. 4 shows an example of the hanging system in which two hanging strips are used to hold a frame.

### DETAILED DESCRIPTION

In the following description, reference is made to the accompanying drawings that form a part hereof, and in which is shown by way of illustration one or more specific exemplary embodiments in which the invention may be practiced. It is to be understood that other embodiments may be utilized and structural changes may be made without departing from the scope of this invention.

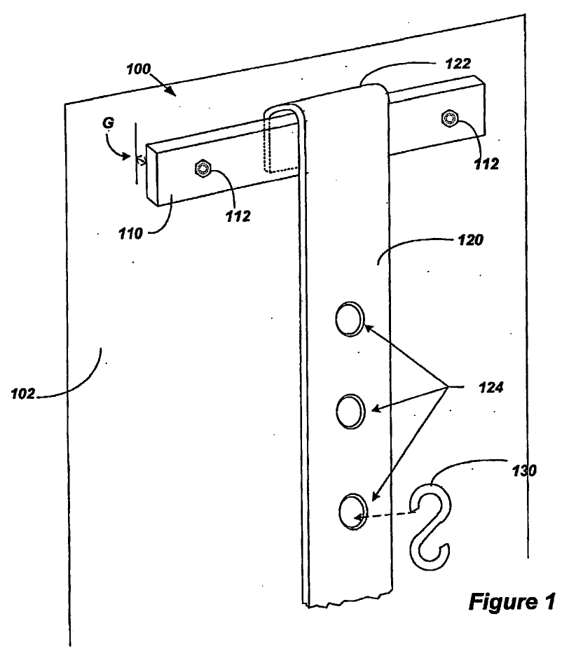

FIG. 1 shows an example of hanging system 100 for hanging frames, artwork, pictures, mirrors, and the like on to a vertical surface such 102 as a wall. The hanging system 100 includes a support bracket 110 and a hanger strip 120 attachable to the support bracket 110. The hanger strip 120 in FIG. 1 further includes at least one hook attachment position 124 or a plurality of hook attachment positions 124 spaced along the length of the hanger strip 120. The hook attachment positions 124 may receive one or more hooks 130 for engaging an object to mount against the vertical surface 102. The hook 130 may be a forward or backward facing hook 130. One ore more hooks 130 may be attached to the plurality of hook attachment positions 124 to provide for the hanging position of the object to be adjustable. Alternatively, one or more hooks 130 may be integrated as part of the hanger strip 120.

One example of a hanging system 100 such as the example in FIG. 1 may be implemented by constructing the support bracket 110 from about a 1″ strip of a metal, such as aluminum although the exact dimensions are not important. The support bracket 110 shown in FIG. 1 is secured or attached to an upper portion of the vertical surface 102 or wall in a manner that allows the hanger strip 120 to engage the support bracket 110. In the example in FIG. 1, the support bracket 110 is a strip of material such as a metal that may be fixed to the vertical surface 102 by, for example, using bolts 112, one on each side of an upper hook section 122 on the hanger strip 120. The support bracket 110 may be secured onto the upper portion of a wall about a distance below the ceiling. The support bracket 110 may also be held a distance G from the wall to leave a gap through which the hanging strip 120 may slip through to permit the upper hook section 122 on the hanging strip 120 to engage with the support bracket 110 so that the hanging strip 120 hangs from the support bracket 110. In one example, the gap G is about ¼″ between the wall and the support bracket 110. The gap may be formed by positioning one or two nuts and a washer between the support bracket 110 and the wall 102. In other examples, the gap G is sufficient to permit the hanging strip 120 to slip through, and may be formed by any other suitable object that may also be used to attach the hanging strip 120 to the vertical surface 102.

The bolts 112 may be positioned at a predetermined distance apart from one another, as necessary to support and distribute the weight of the objects that are to be mounted against the wall. In one example, the bolts 112 may be positioned about 1.8″ apart from one another. Those skilled in the art will understand that any type of bolt or screw or other similar fastening device may be used, subject to the materials from which the wall is constructed. For example, for mounting on a flimsy hardboard wall, anchor screws may be used, which will allow the support bracket 110 to support relatively heavy loads without the necessity of bolting onto the support bracket 110 from behind the hardboard.

In examples of the hanging system 100, the hanger strip 120 may be constructed from a metal strip, wood, plastic, or other material sufficiently rigid to hold the intended objects for hanging. The hanging strip 120 may be aluminum strips, bent at one end to form a hook 118 for attaching the hanger strip 120 to the support bracket 110. The hanger strips 120 may be of any length, as desirable for a particular use, wall height, ceiling height or other similar factor affecting desired length of the strips.

The example mounting system in FIG. 1 includes at least one forward facing hook 130 that may be formed at one end of the hanger strip. Alternatively, as illustrated in FIG. 1, the hanger strip 120 may have holes 124 spaced apart along the length of the hanger strip 120. In the example in FIG. 1, the hanger strip 120 may be ½″ wide and have ⅛″ diameter holes 124 positioned approximately 1½″ apart, along the length of the hanger strip 120. An S-hook 130 may then be placed in the holes 124 for hanging or mounting objects, such as pictures. Those of ordinary skill in the art will appreciate that the dimensions given are merely examples and any suitable dimensions may be used.

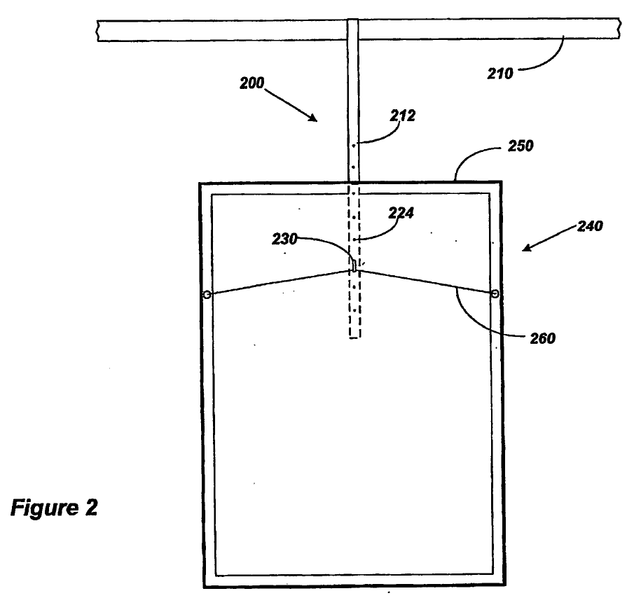

FIG. 2 schematically depicts a hanging system 200 being used to support a frame 240. The hanging system 200 includes a support bracket 210 affixed to a wall. The support bracket 210 supports a hanging strip 212 that hangs from the support bracket 210 by an upper section hook formed on an end of the hanger strip 212. An example of an upper section hook on the hanging strip 212 is shown at 122 in FIG. 1. The hanger strips 212 may be positioned nearly anywhere along the length of the support bracket 210 and, when the hanger strips 212 are of a suitable length, no ladders are need to hang the hanging strips 212 on the support brackets 210. Accordingly, once the support brackets 210 are installed, it may not be necessary to use any tools or ladders to hang the frame 240. Further, placement of the frame 240 may be easily mounted on the wall and the position of the frames 240 may be easily changed, moved, removed or replaced.

Referring to FIG. 2, once the hanger strip 212 is placed in the support bracket 210, an S-hook 230 may be inserted into one of many holes 224 along the hanger strip 212 length. The holes 224 may extend along the length of the hanger strip 212 to allow the object to be mounted on the wall at a desired height. The height of the mounted frame may be flexibly adjusted by moving the hook 230 to another hole 224, or by having other hooks 230 at different holes 224 on the hanger strip 212. The frame 240 in FIG. 2 may have a wire 260 across the back of the frame 240. The frame 240 may be mounted by placing the wire 260 over the S-hook 230 so that the frame 240 hangs at the wire 260 against the wall. The example of FIG. 2 advantageously allows for the mounting height of the frame 240 to be adjusted using the plurality of holes 224 spaced along the length of the hanging strip 212. The holes 224 may be used to allow insertion of the S-hook 230 from which the frame 240 may be mounted.

Those skilled in the art will recognize that other structures can be designed to secure forward or backward facing hooks at various positioned along the hanger strip 212. In addition, other structures capable of mounting an object, besides forward facing hooks, may also be utilized. The hanger strips 212, whether made of metal or plastic, may be manufactured with incisions at regular intervals, so that they can be broken off at the desired length.

Although the examples shown in FIGS. 1 and 2 include the use of a support bracket, in some examples, such as when a wall does not extend all the way to the ceiling and is strong enough to support the entire weight of an object mounted on a hanger strip (without distributing the weight, as provided by the support bracket), the hanger strip may be designed to hang directly over the top of the wall or vertical surface.

The examples shown in FIGS. 1 and 2 may include supporting brackets and hanging strips made of any suitable material, which may be selected based on the anticipated loads to be supported. Materials that may be used for both the supporting bracket and the hanging strip include, without limitation, aluminum, other metals, such as steel, wood, or plastic. Further, the support brackets and hanger strips may be of a narrow or thick design, depending upon the application, and may be made in a number of colors to blend and/or contrast, as desired, with the structure upon which the brackets may be placed.

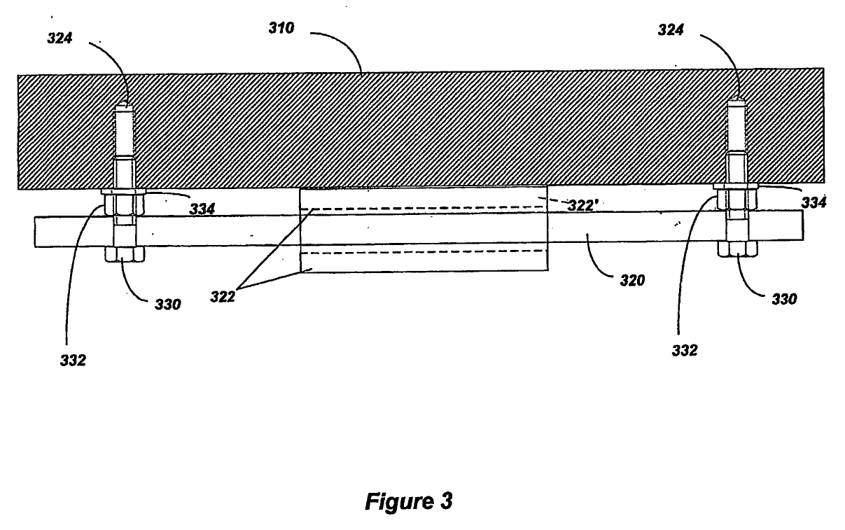

FIG. 3 shows a top view of a hanging system 300 that shows one example of affixing a support bracket 320 to a wall 310. The support bracket 320 may be affixed by two bolts 330 on opposite sides of a hanging strip 322, which hooks over the support bracket 320 and hangs as described above with reference to FIGS. 1 and 2. The bolts 330 may be inserted through a nut 332 and a washer 334 between the support bracket 320 and the wall 310. The bolts 330 may be installed in corresponding threaded holes 324. When installed, the nut 332 and the washer 334 may provide a space through which a hook portion 322′ of the hanging strip 322 may be slipped so that the support bracket 320 may support the hanging strip 322.

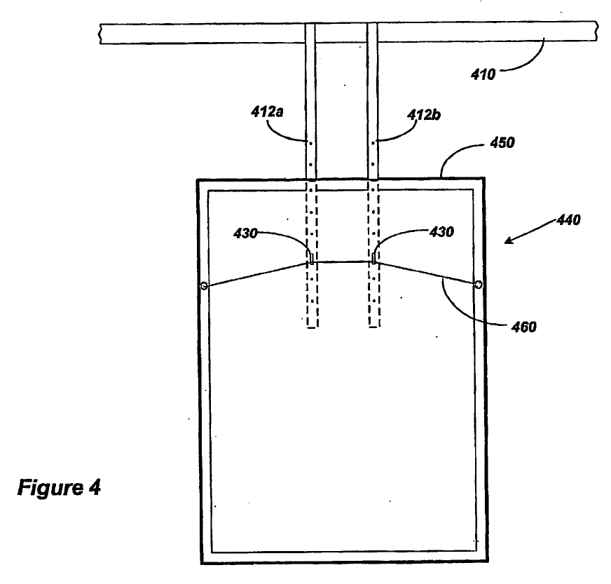

In the example in FIG. 4, the space between the support bracket 320 and the wall 310 may be adjusted by using additional nuts with the first nut 332 to expand the space, or use no nuts 332 (i.e. using washers 334 that are much thinner than the nuts) and use one or more washers 334, or use other objects that have similar functions to nuts and washers.

FIGS. 1-3 describe hanging systems that may be used to mount objects on a vertical surface, such as a wall. Exact implementations may depend on the types of objects that are to be supported by the hanging systems. As described above, the types and weight of the objects may dictate the material and dimensions used in the hanging system. For objects that are very heavy, more than one hanging system may be used. FIG. 4 shows an example in which more than one hanger strip is used to support the object.

The foregoing description of an implementation has been presented for purposes of illustration and description. It is not exhaustive and does not limit the claimed inventions to the precise form disclosed. One skilled in the art will recognize that the securing of the brackets and hangers against one other and other structures in accordance with the invention can be done in a variety or ways without departing from the scope of the invention. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

What is claimed is:

1. A hanging device comprising:
a hanger strip having an upper hook section; and
at least one hook attachment position on a portion of the hanger strip that extends from the upper hook section for attachment of at least one hook.

2. The hanging device of claim 1 where the hook attachment position includes at least one hole to receive the at least one hook.

3. The hanging device of claim 1 where the at least one hook is an ‘S’ shaped hook.

4. The hanging device of claim 1, where the hanging device further includes a support bracket to receive the upper hook of the hanger strip.

5. The hanging device of claim 4 where the support bracket is attached to a vertical surface using attachment objects that permit a gap between the support bracket and the vertical surface, and where the upper hook has a thickness sufficient to slip through the gap.

6. The hanging device of claim 4 where the attachment objects that attach the support bracket to the vertical surface includes at least one bolt and at least one nut between the support bracket and the vertical surface to provide the gap.

7. The hanging device of claim 4 where the attachment objects that attach the support bracket to the vertical surface includes two bolts fed through corresponding holes in the support bracket and corresponding holes in the vertical surface, the bolts further fed through at least one corresponding nut, the nut providing the gap between the vertical surface and the support bracket.

8. A method for hanging an object on a vertical surface comprising:
providing a hanger strip configured to have an upper hook section on one end of the strip and at least one hook attachment position on another end of the strip;
attaching at least one hook to the at least one hook attachment, the at least one hook being operable to receive the object during hanging; and
hooking the upper hook section to the vertical surface.

9. The method of claim 8 where the step of providing the hanger strip includes the steps of:
configuring a strip of material to have an upper hook section and an attachment section.

10. The method of claim 9 where the material is a bendable material and the step of configuring the strip of material to have the upper hook section includes bending the metal to form a hook shape at the upper hook section.

11. The method of claim 9 where the step of configuring the attachment section includes punching at least one hole to permit insertion of a hook.
